(19) United States
(12) Patent Application Publication
(10) Pub. No.: US 2023/0178932 A1
(43) Pub. Date: Jun. 8, 2023

(54) FLOATING MULTI-TERMINAL CONNECTOR

(71) Applicant: P-TWO INDUSTRIES INC., Taoyuan (TW)

(72) Inventor: Pi-Miao Chen, Taoyuan (TW)

(21) Appl. No.: 17/722,094

(22) Filed: Apr. 15, 2022

(30) Foreign Application Priority Data
Dec. 2, 2021 (TW) 110145243

(51) Int. Cl. H01R 13/631; H01R 12/71

(52) U.S. Cl. CPC H01R 13/6315; H01R 12/716; H01R 13/05

(57) ABSTRACT

A floating multi-terminal connector includes a male head, a female seat, a plurality of limiters, a plurality of firs terminals and a plurality of second terminals. The male head includes a first base, a first connecting portion and a plurality of first terminal slots. The female base includes a second base, a second connecting portion, a plurality of second terminal grooves and a plurality of fourth terminal grooves. The numbers of the first terminal grooves, the second terminal grooves, and the fourth terminal grooves are more than or equal to one hundred. The second connecting portion forms a limiting protrusion to correspond to a limiting groove formed by a limiting element. The second connecting portion is suspended on the second base through the second terminals. The second connecting portion provides movement in horizontal and vertical directions through the second terminals, the limiting protrusion and the limiting grooves.

### FIELD OF THE INVENTION

The present invention is related to the technical field of connectors, particularly to one that is applicable in multi-terminals as a floating multi-terminal connector.

### BACKGROUND OF THE INVENTION

Conventionally, connectors are utilized to connect two printed circuit boards for transmitting electricity and data, and according to the required functions of printed circuit board (PCB), several connectors may be put to use at the same time. However, each connector has its own volumes and this will certainly result in consumption of space on the PCBs. As more connectors are put to use, there is less space on the PCBs which makes it much more unfavorable for the design and arrangement of electronic components and electric circuits thereon. On the other hand, to provide multi terminals, e.g. more than a hundred terminals, with a single connector, the assembling process also has to be taken into consideration since it could be a blind assembly process.

Therefore, the present invention provides a floating multi-terminal connector that is able to perform electricity and data transmission via hundreds of terminals, so as to resolve the deficiencies in the prior art.

### SUMMARY OF THE INVENTION

An objective of the present invention is to provide a floating multi-terminal connector that provides more than a hundred terminals for electricity and signal transmission, so that there is more flexibility for the design of circuits and arrangement of electronic components.

Another objective of the present invention is to provide the aforesaid floating multi-terminal connector that has a second connecting portion of a female seat thereof being able to perform horizontal and vertical movements on a second base thereof by arrangement of a second terminal, limiting grooves of limiting elements and limiting protrusions of the second connecting portion, in order to achieve the purpose of easy assembly.

To achieve the objectives, the present invention has a floating multi-terminal connector that comprises a male head, a female seat, a plurality of limiting elements, a plurality of first terminals and a plurality of second terminals. The male head includes a first base, a first connecting portion and a plurality of first terminal grooves. The first base is coupled to the first connecting portion and the first terminal grooves are formed at the first base and the first connecting portion. The first connecting portion forms a first inner space and the first base forms a third inner space. And partial of the first terminal grooves are formed within the first inner space on the inner peripheral wall thereof as another partial of the first terminal grooves formed within the third inner space on the inner peripheral wall thereof. Wherein the amount of first terminal grooves is equal to or more than a hundred. The female seat includes a second base, a second connecting portion, a plurality of second terminal grooves and a plurality of fourth terminal grooves. The second connecting portion forms a second inner space and the second base forms a fourth inner space. The second connecting portion further forms an engaging section corresponding to the first connecting portion for engaging therewith. The second connecting portion is arranged at the engaging section. The second terminal grooves are formed on the inner peripheral wall of the second inner space and the fourth terminal grooves are formed in the fourth inner space on the inner peripheral wall thereof. Wherein the amount of the second terminal grooves and of the fourth terminal grooves are equal to or more than the amount of the first terminal grooves. Both sides of the second connecting portion further include a limiting protrusion. The limiting elements are separately disposed at both sides of the second base, confining partial of the second connecting portion within the fourth inner space; each limiting element further forms a limiting groove corresponding to the limiting protrusion. The first terminals are disposed at the first terminal grooves. The second terminals have an end thereof disposed at the second terminal grooves and the other end at the fourth terminal grooves.

Wherein the second connecting portion is suspended upon the second base by the second terminals, arranged and fixed within the fourth inner space by the limiting elements, and has a limited movement within the fourth inner space due to the confinement of the limiting protrusions and the limiting grooves, thereby the second connecting portion is able to perform movements horizontally and vertically with disposition of the second terminal, the limiting protrusions and the limiting grooves.

In comparison with the conventional floating connectors with multi terminals, the present invention provides one that is applicable in the fields where more than a hundred terminals are utilized. By having one floating multi-terminal connector as presented, the transmission of signals and electricity via a hundred terminals is achievable.

### BRIEF DESCRIPTION OF THE DRAWINGS

FIG. 1 is a perspective view of the present invention, a floating multi-terminal connector, in an embodiment;

FIG. 2(a) is a top plan view of FIG. 1 illustrating a male head thereof engaging a first terminal thereof;

FIG. 2(b) is a bottom plan view of FIG. 1 illustrating the male head engaging the first terminal;

FIG. 2(c) is a front plan view of FIG. 1 illustrating the male head engaging the first terminal;

FIG. 2(d) is a side plan view of FIG. 1 illustrating the male head engaging the first terminal;

FIG. 3 is a cross-sectional view of FIG. 2(d) illustrating the male head engaging the first terminal;

FIG. 4(a) is a top plan view of FIG. 1 illustrating a female seat thereof engaging a second terminal thereof and a limiting element thereof;

FIG. 4(b) is a bottom plan view of FIG. 1 illustrating the female seat engaging the second terminal and the limiting element;

FIG. 4(c) is a front plan view of FIG. 1 illustrating the female seat engaging the second terminal and the limiting element;

FIG. 4(d) is a side plan view of FIG. 1 illustrating the female seat engaging the second terminal and the limiting element; and

FIG. 5 is a cross-sectional view of FIG. 4(d) illustrating the female seat engaging the second terminal and the limiting element.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is as below.

The description of unit, element and component in the present invention uses “one”, “a”, or “an”. The way mentioned above is for convenience, and for general meaning of the category of the present invention. Therefore, the description should be understood as “include one”, “at least one”, and include the singular and plural forms at the same time unless obvious meaning.

The description of comprise, have, include, contain, or another similar semantics has the non-exclusive meaning. For example, an element, structure, product, or device contain multi requirements are not limited in the list of the content, but include another inherent requirement of element, structure, product or device not explicitly listed in the content. In addition, the term “or” is inclusive meaning, and not exclusive meaning.

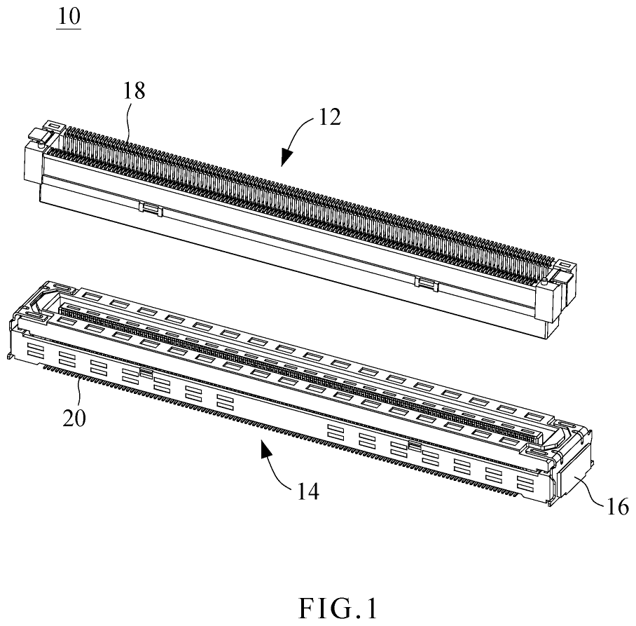

Referring to FIG. 1, it is a perspective view of the present invention, a floating multi-terminal connector 10, in an embodiment. The floating multi-terminal connector 10 comprises a male head 12, a female seat 14, at least one limiting element 16, a plurality of first terminals 18, and a plurality of second terminals 20. In this embodiment, the multi-terminal connector 10 is applied in electrical connection with a first printed circuit board (PCB) (not shown) and a second printed circuit board (PCB) (not shown). For instance, it is applicable having the male head 10 electrically connected with the first PCB and the female sear 14 electrically connected with the second PCB.

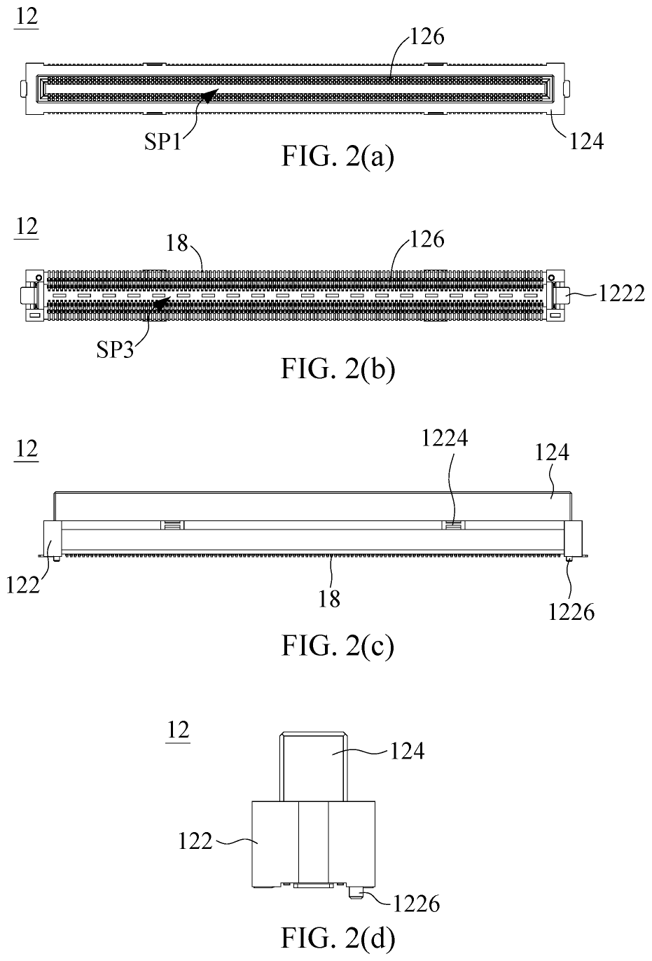

With reference to FIGS. 2(a)-(d), there are plan views of FIG.1 illustrating the male head 12 engaging the first terminals 18 from different angles, among which FIG. 2(a) being a top plan view thereof, FIG. 2(b) being a bottom plan view thereof, FIG. 2(c) being a front plan view thereof, and FIG. 2(d) being a side plan view thereof.

The male head 10 includes a first base 122, a first connecting portion 124 and a plurality of first terminal grooves 126.

The first base 122 is coupled to the first connecting portion 124; in this embodiment, the first base 122 and the first connecting portion 124 are rectangular. The first connecting portion 124 forms a first inner space SP1 and the first base 122 forms a third inner space SP3; in this embodiment, the first base 122 and the first connecting portion 124 are form in an one piece structure. In other embodiments, the first base 122 and the first connecting portion 124 are separable components of the present invention.

The plurality of first terminal grooves 126 are formed between the first base 122 and the first connecting portion 124. Partial of the first terminal grooves 126 is formed within the first inner space SP1 on an inner peripheral wall thereof and another partial of the first terminal grooves 126 is formed within the third inner space SP3 on an inner peripheral wall thereof. In this embodiment, the first inner space SP1 is not connecting to the third inner space SP3, and the amount of the first terminal grooves 126 is 240. The amount of the first terminal grooves 126 is arranged for application in multi-terminal devices; therefore, a number thereof equals to or is more than a hundred is within the scope of the present invention.

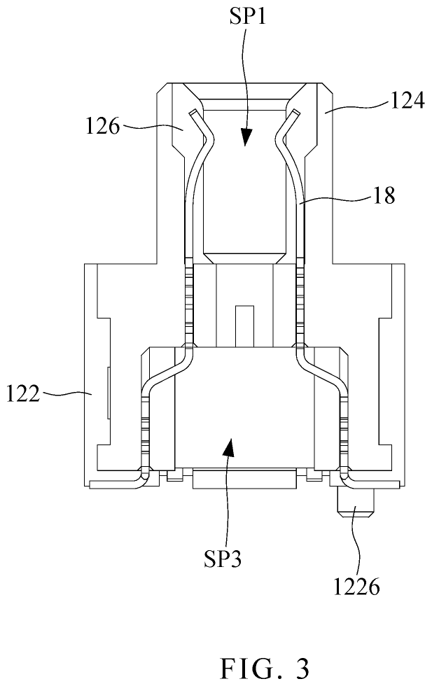

The first terminals 18 is disposed at the first terminal grooves 126. In this embodiment, the amount of the first terminals 18 is 240. Additionally, an end of the first terminals 18 are arranged at the first terminal grooves 126, exposed on the inner peripheral wall of the first inner space SP1, and the other end of the first terminals 18 are exposed on the inner peripheral wall of the third inner space SP3, in order to be connected with the first PCB (not shown). FIG. 3 is a cross-sectional view of FIG. 2(d), illustrating the male head 12 engaging the first terminals 18, as a reference herewith.

In another embodiment, the present invention further includes a plurality of fixing elements 1222 separately disposed at both sides of the first base 122 for the first base to be fixedly engaged with the first PCB (not shown)

In another embodiment, the present invention further includes a plurality of fastening sections 1224 formed at both sides (the long sides) of the first base 122 for further engaging a fastening element (not shown) for covering the present invention and avoiding dusts entering into the first inner space SP1.

In another embodiment, the present invention further includes an engaging element 1226 formed on the first base 122 for fixedly engaging the external first PCB (not shown)

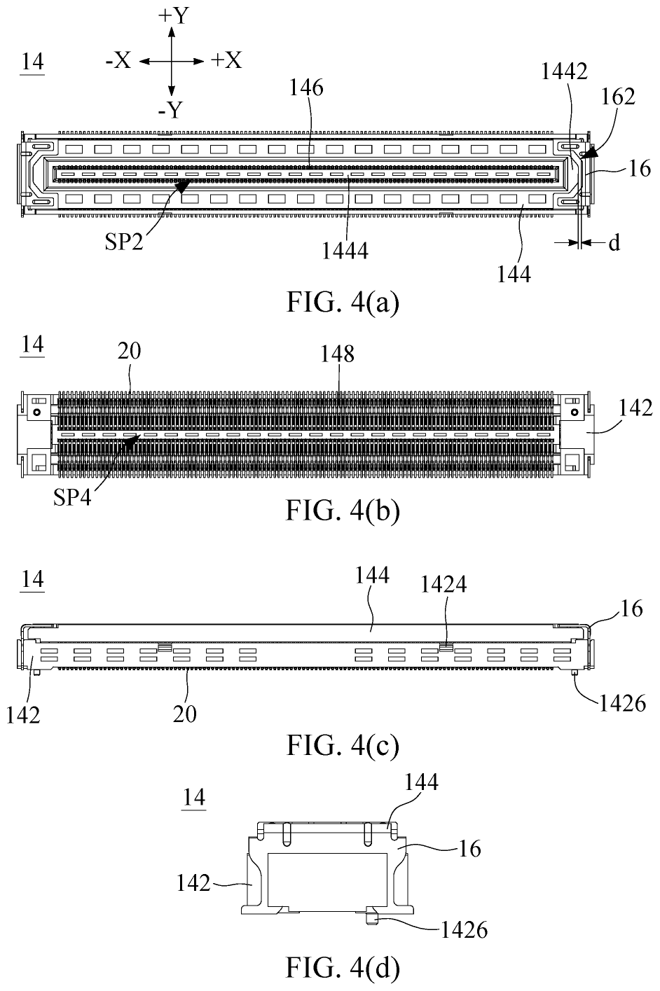

With reference to FIGS. 4(a)-4(d), there are plan views of FIG.1 illustrating the female seat 14 engaging the second terminals 20 and the limiting elements 16 from different angles, among which FIG. 4(a) being a top plan view thereof, FIG. 4(b) being a bottom plan view thereof, FIG. 4(c) being a front plan view thereof, and FIG. 4(d) being a side plan view thereof.

The female seat 14 includes a second base 142, a second connecting portion 144, a plurality of second terminal grooves 146 and a plurality of fourth terminal grooves 148. In this embodiment, the second and fourth terminal grooves 146, 148 are rectangular.

The second connecting portion 144 forms a second inner space SP2 and the second base 142 forms a fourth inner space SP4. In addition, the second connecting portion 144 is disposed within the fourth inner space SP4 and further forms an engaging section 1444 corresponding to the first connecting portion 124 for engaging therewith; both sides of the second connecting portion 144 further include a limiting protrusion 1442.

The second terminal grooves 146 are formed at the engaging section 1444 and the fourth terminal grooves 148 are formed within the fourth inner space SP4 on an inner peripheral wall thereof, wherein the amount of the second terminal grooves 146 and the amount of the fourth terminal grooves 148 are equal to or more than the amount of the first terminal grooves 126. In this embodiment, the amounts of the second and fourth terminal grooves 146, 148 are both 240. The amounts thereof are arranged for application in multi-terminal devices; therefore, the number thereof individually equals to or is more than a hundred is within the scope of the present invention.

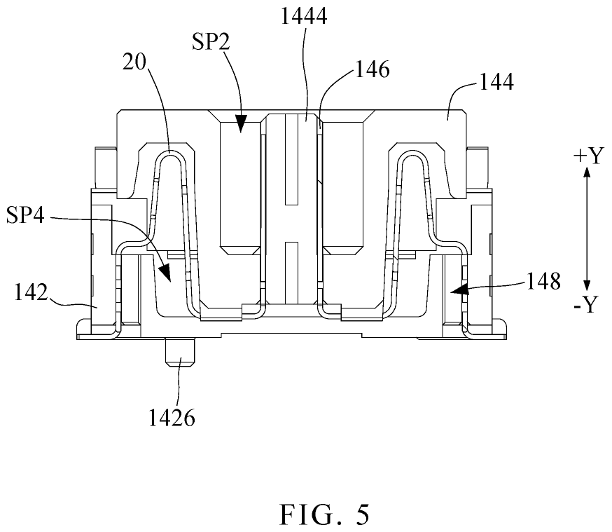

The plurality of second terminals 20 have an end thereof disposed at the plurality of second terminal grooves 146 and the other end at the fourth terminal grooves 148. In this embodiment, the number of the second terminals 20 is 240. In addition, the ends of the second terminals 20 arranged at the second terminal grooves 146 are exposed at the engaging section 1444 as well, and the other ends of the second terminals 20 arranged at the fourth terminals 148 are exposed in the fourth inner space SP4 on the inner periphery wall thereof for connecting with the second PCB (not shown). Besides, the second terminals 20 have a curved structure so that when encountering an external force, the second terminals 20 is able to be deformed thereby. And the second connecting portion 144 is also able to perform movements such as a vertical movement upon second base 142 due to the deformation of the second terminals 20. FIG. 5 is a cross-sectional view of FIG. 4(d), illustrating the female seat 14 engaging the second terminals 20, as a reference herewith. The vertical direction mentioned above is the direction along +Y or −Y axis as shown in FIG. 5.

In another embodiment, the present invention further includes a plurality of fixing elements (not shown) separately disposed at both side of the second base 142 thereof for the second base 142 to be fixedly engaged with the second PCB (not shown).

In another embodiment, the present invention further includes a plurality of fastening sections 1424 formed at both sides (the long sides) of the second base 142 thereof for further engaging a fastening element (not shown) for covering the present invention and avoiding dusts entering into the second inner space SP2.

In another embodiment, the present invention further includes an engaging element 1426 formed on the second base 142 for fixedly engaging the external second PCB (not shown).

Returning to FIGS. 4(a)-4(b), in this embodiment, the limiting element 16 is arranged as a pair, each disposed at a side of the second base 142. The limiting elements 16 confine partial of the second connecting portion 144 within the fourth inner space SP4 and each thereof further forms a limiting groove 162 corresponding to the limiting protrusions 1442. When the second connection portion 144 is arranged at the second base 142, the limiting protrusions 1442 and the limiting grooves 162 have gaps d in-between correspondingly. The gaps d thereby determine the displacing distance of the second connecting portion 144 on the second base 142, especially when it is a horizontal movement. In this embodiment, the limiting protrusions 1442 and the limiting grooves 162 are correspondingly trapezoid shaped. For reference herewith, the horizontal direction mentioned above is along the +X, −X, +Y or −Y axis or along a combined direction of said axes. And it is applicable to solder the limiting elements 16 to the second PCB (not shown).

With the aforesaid connections, the second connecting portion 144 is suspended upon the second base 20 by the plurality of second terminals 20 and arranged and fixed within the fourth inner space SP4 by the limiting elements 16. Also the second connecting portion 144 has a limited movement within the fourth inner space SP4 due to the confinement of the limiting protrusions 1442 and the limiting grooves 162. With the disposition of the second terminal 20, the limiting protrusions 1442 and the limiting grooves 162, the second connecting portion 144 is thereby able to perform movement horizontally and vertically.

The present invention is disclosed by the preferred embodiment in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

1. A floating multi-terminal connector comprising:
a male head including a first base, a first connecting portion and a plurality of first terminal grooves, the first base coupled to the first connecting portion and the plurality of first terminal grooves formed between the first base and the first connecting portion; the first connecting portion forming a first inner space, the first base forming a third inner space, and partial of the first terminal grooves formed within the first inner space on an inner peripheral wall thereof as another partial of the first terminal grooves formed within the third inner space on an inner peripheral wall thereof, wherein an amount of the plurality of first terminal grooves is no less than a hundred;
a female seat including a second base, a second connecting portion, a plurality of second terminal grooves and a plurality of fourth terminal grooves, the second connecting portion forming a second inner space and the second base forming a fourth inner space, the second connecting portion further forming an engaging section corresponding to the first connecting portion for engaging therewith; the second connecting portion disposed within the fourth inner space, the plurality of second terminal grooves formed at the engaging section, and the plurality of fourth terminal grooves formed within the fourth inner space on an inner peripheral wall thereof, wherein an amount of the plurality of the second terminal grooves and an amount of the plurality of the fourth terminal grooves are no less than an amount of the first terminal grooves, and both sides of the second connecting portion further include a limiting protrusion;
a plurality of limiting elements, separately disposed at both sides of the second base, the limiting elements confining partial of the second connecting portion within the fourth inner space and each limiting element further forming a limiting groove corresponding to the limiting protrusion;
a plurality of first terminals disposed at the plurality of first terminal grooves; and
a plurality of second terminals having an end thereof disposed at the plurality of second terminal grooves and the other end at the fourth terminal grooves;
wherein the second connecting portion is suspended upon the second base by the plurality of second terminals, arranged and fixed within the fourth inner space by the limiting elements, and has a limited movement within the fourth inner space due to the confinement of the limiting protrusions and the limiting grooves, thereby the second connecting portion is able to perform movements horizontally and vertically with disposition of the second terminal, the limiting protrusions and the limiting grooves.

2. The floating multi-terminal connector defined in claim 1, wherein the first base and the first connecting portion are form in one piece.

3. The floating multi-terminal connector defined in claim 1, wherein the first inner space is not connecting to the third inner space.

4. The floating multi-terminal connector defined in claim 1, comprising a plurality of fixing elements separately disposed at both sides of the first base thereof for the first base to be fixedly engaged with an external first printed circuit board or separately disposed at both side of the second base thereof for the second base to be fixedly engaged with an external second printed circuit board.

5. The floating multi-terminal connector defined in claim 1, comprising a plurality of fastening sections formed at both sides of the first base thereof or at both sides of the second base thereof, for further engaging an external fastening element for covering.

6. The floating multi-terminal connector defined in claim 1, wherein the plurality of limiting protrusions and the plurality of limiting grooves have corresponding gaps in-between.

7. The floating multi-terminal connector defined in claim 6, wherein the limiting protrusions thereof and the limiting grooves thereof are correspondingly trapezoid shaped.

8. The floating multi-terminal connector defined in claim 1, wherein the second connecting portion thereof has a vertical movement upon the second base thereof due to the plurality of the second terminals thereof.

9. The floating multi-terminal connector defined in claim 1, wherein the second connecting portion thereof has a horizontal movement upon the second base thereof due to the limiting protrusions thereof and the limiting grooves thereof.

10. The floating multi-terminal connector defined in claim 1, wherein comprising an engaging element formed on the first base thereof for fixedly engaging an external first printed circuit board, or the engaging element is formed on the second base thereof for fixedly engaging an external second printed circuit board.
